(19) United States
(12) Patent Application Publication
(10) Pub. No.: US 2015/0152951 A1
(43) Pub. Date: Jun. 4, 2015

(54) TORQUE CONVERTER WITH INTEGRATED TRIPLE PLATE LOCK-UP CLUTCH

(71) Applicant: Schaeffler Technologies GmbH & Co. KG

(72) Inventor: Peter Rentfrow, Wooster, OH (US)

(21) Appl. No.: 14/549,127

(22) Filed: Nov. 20, 2014

Related U.S. Application Data
(60) Provisional application No. 61/911,227, filed on Dec. 3, 2013.

(51) Int. Cl. F16H 45/02

(52) U.S. Cl. CPC F16H 45/02; F16H 2045/0284

(57) ABSTRACT

A torque converter, including: an axis of rotation; a cover; an impeller non-rotatably connected to the cover; a turbine including a turbine shell; a stator; and an integrated clutch. The clutch includes: a piston extending radially outward from the turbine shell and non-rotatably connected to the turbine shell; a plurality of tabs extending from the piston in an axial direction; a first clutch plate non-rotatably connected to the plurality of tabs; a second clutch plate non-rotatably connected to the cover and disposed between the piston and the first clutch plate; and respective friction material axially located in respective gaps between the piston, the first and second clutch plates, and the cover.

### CROSS-REFERENCE TO RELATED APPLICATIONS

This application claims the benefit under 35 U.S.C. §119(e) of U.S. Provisional Patent Application No. 61/911,227, filed Dec. 3, 2013, which application is incorporated herein by reference in its entirety.

### TECHNICAL FIELD

The present disclosure relates generally to a lock-up clutch for a torque converter, and, more specifically, to a lock-up clutch integrated with a turbine and including triple plates.

### BACKGROUND

It is known to integrate a lock-up clutch for a torque converter with a turbine for the torque converter. To increase the torque-bearing capacity of the integrated clutch the radius of the clutch can be increased. However, to accommodate the increased radius of the clutch, the overall radial extent of the torque converter must also be increased, which is generally undesirable.

### SUMMARY

The present disclosure broadly comprises a torque converter, including: an axis of rotation; a cover; an impeller non-rotatably connected to the cover; a turbine including a turbine shell; a stator; and an integrated clutch. The clutch includes: a piston extending radially outward from the turbine shell and non-rotatably connected to the turbine shell; a plurality of tabs extending from the piston in an axial direction; a first clutch plate non-rotatably connected to the plurality of tabs; a second clutch plate non-rotatably connected to the cover and disposed between the piston and the first clutch plate; and respective friction material axially located in respective gaps between the piston, the first and second clutch plates, and the cover.

The present disclosure broadly comprises a torque converter, including: an axis of rotation; a cover; an impeller non-rotatably connected to the cover; a turbine including a turbine shell; a stator; and an integrated clutch. The integrated clutch includes: a piston extending radially outward from the turbine shell and non-rotatably connected to the turbine shell; a plurality of rivets fixedly secured to the piston and extending from the piston in an axial direction; a first clutch plate non-rotatably connected to the plurality of rivets; a second clutch plate non-rotatably connected to the cover and disposed between the piston and the first clutch plate; and respective friction material axially located in respective gaps between the piston, the first and second clutch plates, and the cover. When the integrated clutch is open, the piston and the first clutch plate are independently rotatable with respect to the cover and the second clutch plate. When the integrated clutch is closed the piston, the first clutch plate, the cover, and the second clutch plate are non-rotatably connected.

The present disclosure broadly comprises a torque converter, including: an axis of rotation; a cover; an impeller non-rotatably connected to the cover; a turbine including a turbine shell; a stator; an integrated clutch; a first chamber at least partially formed by the cover and the turbine shell; and a second chamber at least partially formed by the impeller and the turbine. The integrated clutch includes: a piston extending radially outward from the turbine shell and non-rotatably connected to the turbine shell; a plurality of tabs extending from the piston in an axial direction; a first clutch plate non-rotatably connected to the plurality of tabs; and a second clutch plate non-rotatably connected to the cover and disposed between the piston and the first clutch plate. To close the integrated clutch, the torque converter is arranged to control respective pressures in the first and second chambers so that pressure in the first chamber is greater than pressure in the second chamber. To open the integrated clutch, the torque converter is arranged to control respective pressures in the first and second chambers so that pressure in the second chamber is greater than pressure in the first chamber.

### BRIEF DESCRIPTION OF THE DRAWINGS

The nature and mode of operation of the present disclosure will now be more fully described in the following detailed description of the present disclosure taken with the accompanying figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is partial cross-sectional view of a torque converter with an integrated triple-plate clutch;

FIG. 3 is a detail of area 3/6 in FIG. 2;

FIG. 4 is a detail of a clutch plate and tabs shown in FIG. 2;

FIG. 5 is a detail of an individual tab;

FIG. 6 is a detail of area 3/6 in FIG. 2; and,

FIG. 7 is a detail of a rivet ring with tabs.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the present disclosure, the preferred methods, devices, and materials are now described.

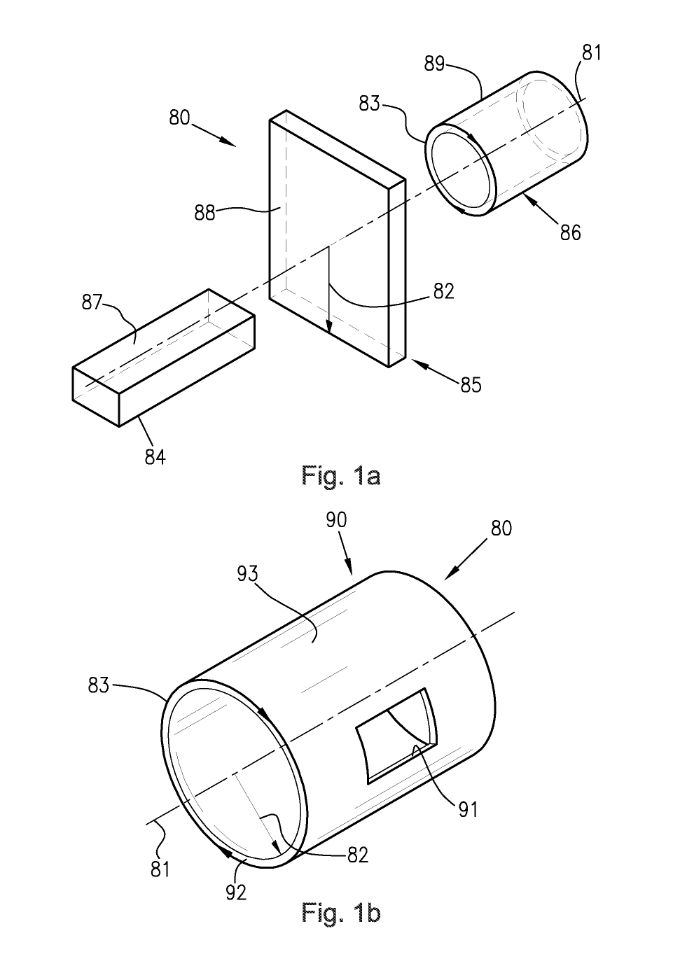

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is a circumferential surface.

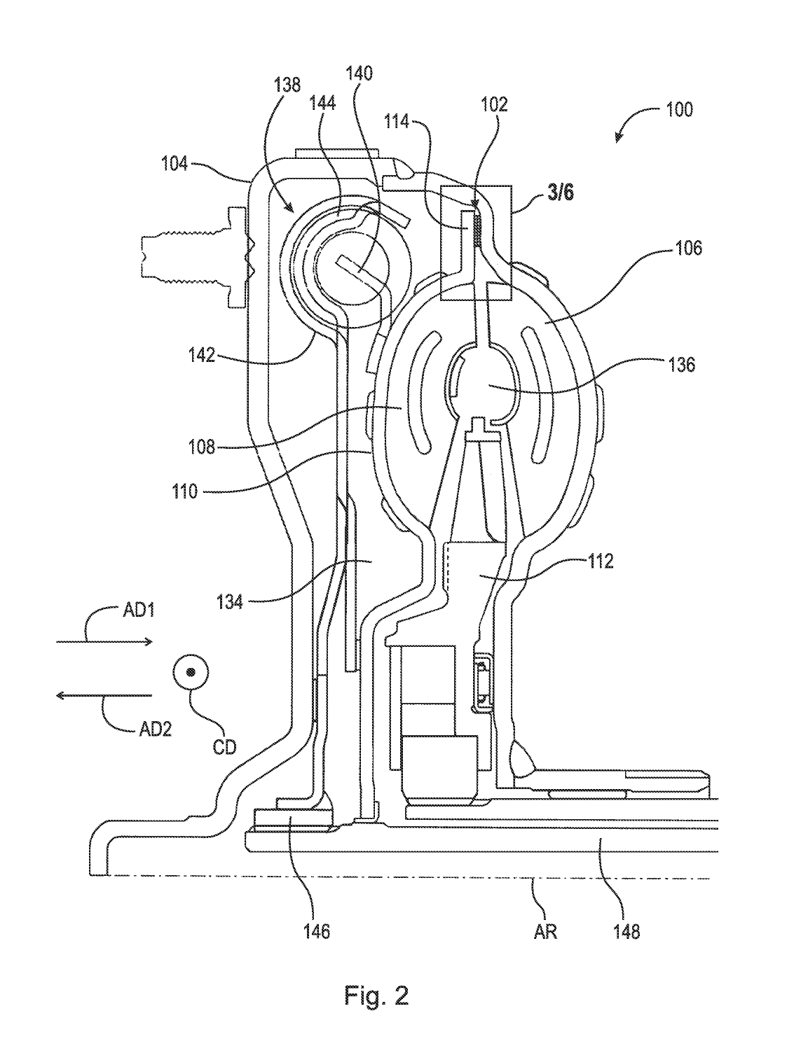

FIG. 2 is partial cross-sectional view of torque converter 100 with integrated triple-plate clutch 102.

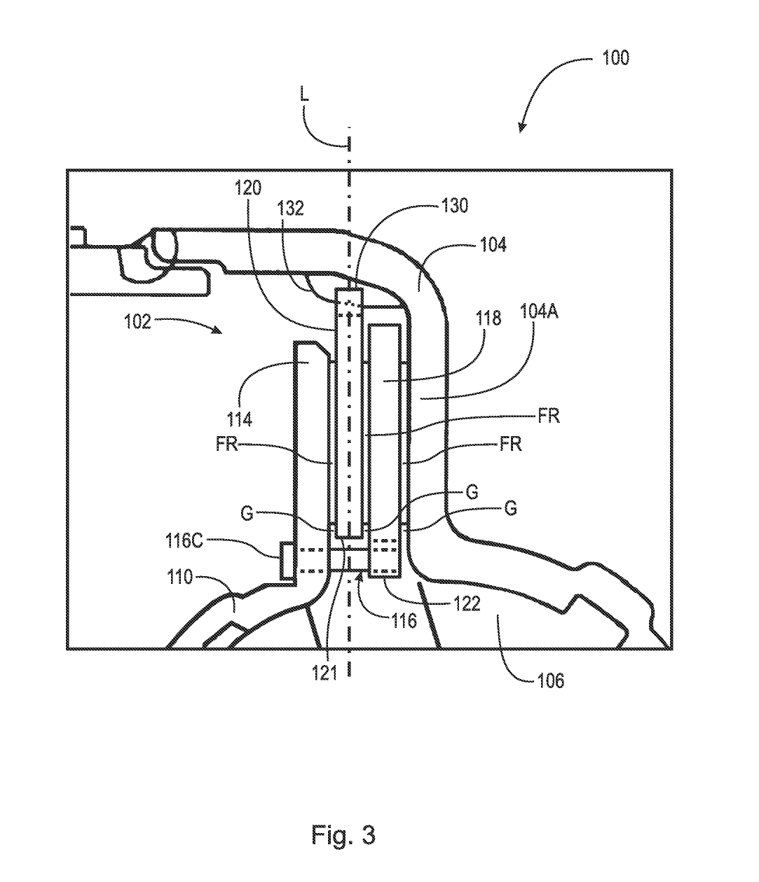

FIG. 3 is a detail of area 3 in FIG. 1. Torque converter 100 includes axis of rotation AR, cover 104, impeller 106 non-rotatably connected to the cover, turbine 108 including turbine shell 110, and stator 112. By “non-rotatably connected” we mean that impeller 106 and the cover are connected together such that any rotation of the impeller causes a same rotation of the cover and any rotation of the cover causes the same rotation of the impeller. That is, the impeller and the cover are a single unit in terms of rotation. Clutch 102 includes piston 114 extending radially outward from turbine shell 110 and non-rotatably connected to turbine shell 110, tabs 116 extending from the piston 114 in axial direction AD1, clutch plate 118 non-rotatably connected to tabs 116, and clutch plate 120 non-rotatably connected to cover 104 and axially disposed between piston 114 and clutch plate 118. Clutch 102 includes friction material FR axially located in gaps G between piston 114, clutch plates 118 and 120, and cover 104. In an example embodiment, piston 114 is integrally formed with material forming turbine shell 110.

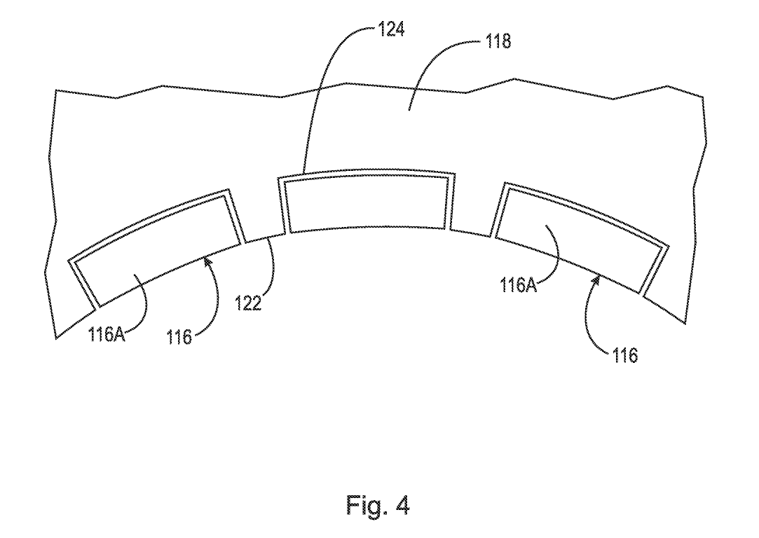

FIG. 4 is a detail of clutch plate 118 and tabs 116 shown in FIG. 3. Tabs 116 are located radially inward of surface 121 of clutch plate 120 and line L orthogonal to axis of rotation AR passes through the clutch plate 120 and a tab 116. In an example embodiment, clutch plate 118 includes radially inwardly facing side 122 with radially outwardly extending indentations 124. Tabs 116 are disposed in radially outwardly extending indentations 122. In an example embodiment, clutch plate 118 is axially displaceable with respect to tabs 116. That is, there is sufficient play in the interface of tabs 116 and plate 118 to enable axial movement of plate 118 while non-rotatably connecting tabs 116 and plate 118.

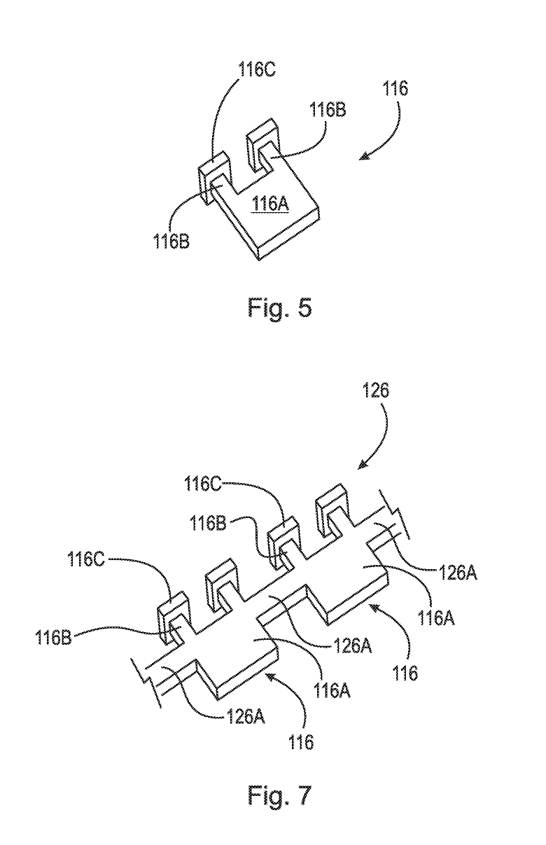

FIG. 5 is a detail of an individual tab 116. In an example embodiment, each tab 116 is a respective rivet passing through piston 114 and fixedly connected to piston 114. In an example embodiment, the respective rivets are sheet metal rivets as described in commonly owned U.S. Pat. No. 8,328,490, which patent is incorporated herein by reference. For example, each tab 116 includes body portion 116A disposed in a respective indentation 122, stems 116B that pass through piston 114, and head 116C.

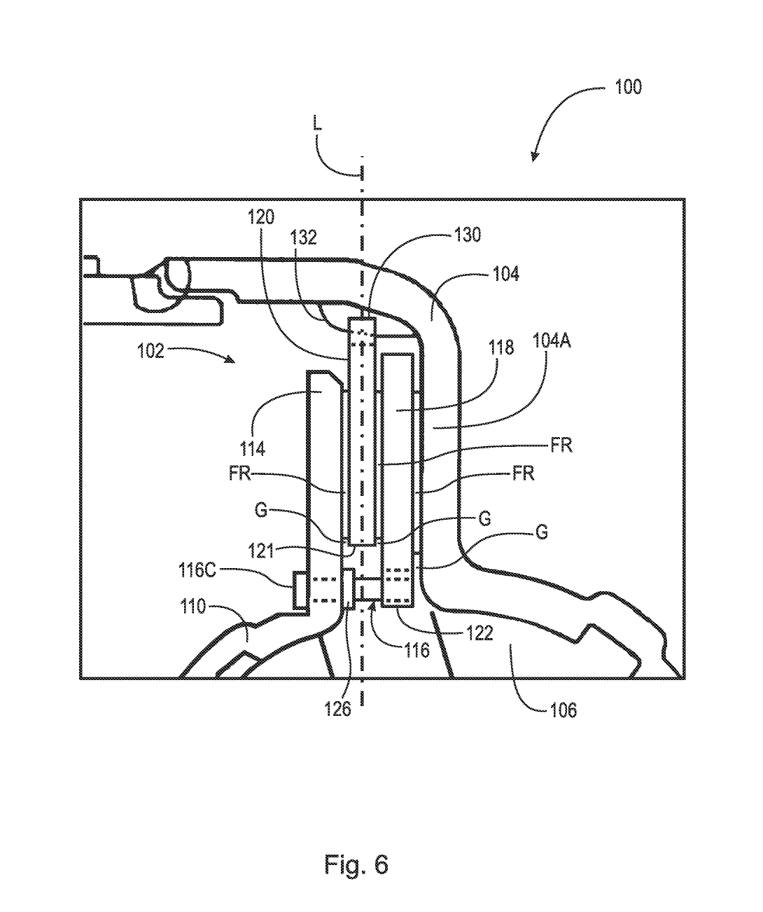

FIG. 6 is a detail of area 3/6 in FIG. 2.

FIG. 7 is a detail of rivet ring 126 with tabs. In an example embodiment, torque converter 100 includes annular-shaped rivet ring 126 including tabs 116. That is, tabs 116 are integrally formed with ring 126. For example, each tab 116 in ring 126 is joined to adjacent tabs by respective bridge portions 126A.

In an example embodiment, plate 120 includes radially outwardly extending splines 130 and cover 104 includes radially inwardly extending splines 132 interleaved with radially outwardly extending splines 130 in circumferential direction CD. In an example embodiment, radially inwardly extending splines 132 are formed of material forming cover 104. In an example embodiment (not shown), torque converter 100 includes an annular-shaped clutch basket fixedly secured to cover 104 and including splines 132.

Torque converter 100 includes chambers 134 and 136. Chamber 134 is at least partially formed by cover 104 and turbine shell 110. Chamber 136 is at least partially formed by impeller 106 and turbine 108. To close clutch 102, torque converter 100 is arranged to control respective pressures in chambers 134 and 136 so that pressure in chamber 134 is greater than pressure in chamber 136. This pressure differential urges turbine 108, and subsequently piston 114, in axial direction AD1 so that that the piston clamps clutch plates 118 and 120 to portion 104A of the cover, non-rotatably connecting turbine 108 and cover 104. That is, piston 114, plates 118 and 120, and cover 104 are non-rotatably connected.

To close clutch 102, torque converter 100 is arranged to control respective pressures in chambers 134 and 136 so that pressure in chamber 136 is greater than pressure in chamber 134. This pressure differential urges turbine 108, and subsequently piston 114, in axial direction AD2, separating piston 114 from clutch plate 120. When clutch 102 is open, piston 114 and plate 118 rotate together (via tabs 116), cover 104 and plate 120 rotate together, and piston 108 and plate 118 are independently rotatable with respect to cover 104 and plate 120.

In an example embodiment, torque converter 100 includes damper 138 with drive plate 140 non-rotatably connected to turbine shell 110, output plate 142, and at least one spring 144 engaged with plates 140 and 142. Plate 142 is non-rotatably connected to output hub 146 arranged to non-rotatably connect to input shaft 148 for a transmission.

When clutch 102 is open, torque applied to cover 104, for example, by an engine in a vehicle (not shown), rotates impeller 106 and fluid coupling of impeller 106 and turbine 108 through stator 112 transmits torque from the cover to output hub 146 through turbine shell 110 and damper 138. When clutch 102 is closed, cover 102 transmit torque directly to turbine shell 110 and shell 110 transmits the torque to hub 146 via damper 138.

Advantageously, clutch plate 118 increases the torque-bearing capacity of clutch 102 without requiring an increase in the radial extent of clutch 102 or torque converter 100.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A torque converter, comprising:
an axis of rotation;
a cover;
an impeller non-rotatably connected to the cover;
a turbine including a turbine shell;
a stator; and,
an integrated clutch including:
a piston extending radially outward from the turbine shell and non-rotatably connected to the turbine shell;
a plurality of tabs extending from the piston in a first axial direction;
a first clutch plate non-rotatably connected to the plurality of tabs; and,
a second clutch plate non-rotatably connected to the cover and disposed between the piston and the first clutch plate.

2. The torque converter of claim 1, further comprising respective friction material axially located in respective gaps between the piston, the first and second clutch plates, and the cover.

3. The torque converter of claim 1, wherein the piston is integrally formed with material forming the turbine shell.

4. The torque converter of claim 1, wherein:
the plurality of tabs are located radially inward of the second clutch plate; and,
a line orthogonal to the axis of rotation passes through the second clutch plate and a tab from the plurality of tabs.

5. The torque converter of claim 1, wherein:
the second clutch plate includes a radially inwardly facing side with a plurality of radially outwardly extending indentations; and,
the plurality of tabs is disposed in the plurality of radially outwardly extending indentations.

6. The torque converter of claim 1, wherein the first clutch plate is axially displaceable with respect to the plurality of tabs.

7. The torque converter of claim 1, wherein each tab in the plurality of tabs is a respective rivet passing through the piston.

8. The torque converter of claim 1, further comprising:
an annular-shaped rivet ring fixedly secured to the piston and including the plurality of tabs.

9. The torque converter of claim 1, wherein:
the second clutch plate includes a plurality of radially outwardly extending splines; and,
the cover includes a plurality of radially inwardly extending splines interleaved with the plurality of radially outwardly extending splines in a circumferential direction.

10. The torque converter of claim 9, wherein the plurality of radially inwardly extending splines are formed of material forming the cover.

11. The torque converter of claim 1, further comprising:
a first chamber at least partially formed by the cover and the turbine shell; and,
a second chamber at least partially formed by the impeller and the turbine, wherein:
to close the integrated clutch, the torque converter is arranged to control respective pressures in the first and second chambers so that pressure in the first chamber is greater than pressure in the second chamber; and,
to open the integrated clutch, the torque converter is arranged to control respective pressures in the first and second chambers so that pressure in the second chamber is greater than pressure in the first chamber.

12. The torque converter of claim 1, wherein:
in response to pressure in the first chamber being greater than pressure in the second chamber, the turbine and piston are arranged to displace in the first axial direction; and,
in response to pressure in the second chamber being greater than pressure in the first chamber, the turbine and the piston are arranged to displace in a second axial direction, opposite the first axial direction.

13. The torque converter of claim 1, wherein:
when the integrated clutch is open, the piston and the first clutch plate are independently rotatable with respect to the cover and the second clutch plate; and,
when the integrated clutch is closed the piston, the first clutch plate, the cover, and the second clutch plate are non-rotatably connected.

14. A torque converter, comprising:
an axis of rotation;
a cover;
an impeller non-rotatably connected to the cover;
a turbine including a turbine shell;
a stator; and,
an integrated clutch including:
a piston extending radially outward from the turbine shell and non-rotatably connected to the turbine shell;
a plurality of rivets fixedly secured to the piston and extending from the piston in an axial direction;
a first clutch plate non-rotatably connected to the plurality of rivets; and,
a second clutch plate non-rotatably connected to the cover and disposed between the piston and the first clutch plate, wherein:
when the integrated clutch is open, the piston and the first clutch plate are independently rotatable with respect to the cover and the second clutch plate; and,
when the integrated clutch is closed the piston, the first clutch plate, the cover, and the second clutch plate are non-rotatably connected.

15. The torque converter of claim 14, wherein the piston is integrally formed with material forming the turbine shell.

16. The torque converter of claim 14, wherein:
the plurality of rivets are located radially inward of the second clutch plate; and,
a line orthogonal to the axis of rotation passes through the second clutch plate and a rivet from the plurality of rivets.

17. The torque converter of claim 14, wherein:
the second clutch plate includes a radially inwardly facing side with a plurality of radially outwardly extending indentations; and,
the plurality of tabs is disposed in the plurality of radially outwardly extending indentations.

18. The torque converter of claim 14, wherein the first clutch plate is axially displaceable with respect to the plurality of tabs.

19. The torque converter of claim 14, further comprising:
a first chamber at least partially formed by the cover and the turbine shell; and,
a second chamber at least partially formed by the impeller and the turbine, wherein:
to close the integrated clutch, the torque converter is arranged to control respective pressures in the first and second chambers so that pressure in the first chamber is greater than pressure in the second chamber; and,
to open the integrated clutch, the torque converter is arranged to control respective pressures in the first and second chambers so that pressure in the second chamber is greater than pressure in the first chamber.

20. A torque converter, comprising:
an axis of rotation;
a cover;
an impeller non-rotatably connected to the cover;
a turbine including a turbine shell;
a stator;
an integrated clutch including:
a piston extending radially outward from the turbine shell and non-rotatably connected to the turbine shell;
a first clutch plate including a plurality of indentations;
an annular ring fixedly secured to the piston and including a plurality of tabs extending from the annular ring in a first axial direction and disposed in the plurality of indentations;
a second clutch plate non-rotatably connected to the cover and disposed between the piston and the first clutch plate;
a first chamber at least partially formed by the cover and the turbine shell; and,
a second chamber at least partially formed by the impeller and the turbine, wherein:
to close the integrated clutch, the torque converter is arranged to control respective pressures in the first and second chambers so that pressure in the first chamber is greater than pressure in the second chamber and the turbine and piston displace in the first axial direction; and,
to open the integrated clutch, the torque converter is arranged to control respective pressures in the first and second chambers so that pressure in the second chamber is greater than pressure in the first chamber and the turbine and piston displace in a second axial direction opposite the first axial direction.
